(19) United States
(12) Patent Application Publication
(10) Pub. No.: US 2026/0369731 A1
(43) Pub. Date: Nov. 19, 2026

(54) REINFORCING PLATE FOR A THERMAL REGULATION DEVICE

(71) Applicant: VALEO SYSTEMES THERMIQUES, Le Mesnil-Saint-Denis (FR)

(72) Inventors: Herve Bourgeais, Le Mesnil Saint Denis (FR); Nicolas Pageard, Le Mesnil Saint Denis (FR)

(73) Assignee: VALEO SYSTEMES THERMIQUES, Le Mesnil-Saint-Denis (FR)

(21) Appl. No.: 19/133,709

(22) PCT Filed: Nov. 24, 2023
(86) PCT No.: PCT/EP2023/082970

§ 371 Date: May 29, 2025

(30) Foreign Application Priority Data
Nov. 28, 2022 (FR) FR2212453

(51) Int. Cl. H01M 10/6556; B60L 50/64; H01M 10/613; H01M 10/625; H01M 10/6554; H01M 10/6567

(52) U.S. Cl. CPC H01M 10/6556; H01M 10/613; H01M 10/625; H01M 10/6554; H01M 10/6567; B60L 50/64; H01M 2220/20

(57) ABSTRACT

The invention relates to a thermal module (300) comprising a thermal regulation device (100), in particular a cooling device, for an electrical component liable to give off heat during operation, in particular for an electrical energy storage module, this device (100) comprising an upper plate (2) and a lower plate (3) assembled with the upper plate (2) to together form a plurality of circulation channels (4) for a heat transfer fluid, characterized in that the module (300) comprises at least one reinforcing plate (1) arranged on at least one portion of the lower plate (3).

### TECHNICAL FIELD

The present invention relates to a reinforcing plate for a thermal regulation device, in particular a cooling device, in particular for an electrical component liable to give off heat during operation, in particular a device for cooling at least one battery or battery cells of a vehicle, for example a motor vehicle, but also for fixed facilities such as for example computer servers or wind turbines. The vehicle may be a land vehicle, marine vehicle or air vehicle.

The invention notably relates to plate heat exchangers intended for the circulation of a refrigerant fluid for cooling the batteries of electric or hybrid vehicles.

### PRIOR ART

To improve heat conduction between the heating elements in operation and the thermal regulation device, thermal paste is placed between them. When these heating elements are assembled with the thermal regulation device, this gives rise to mechanical compression forces on the thermal regulation device. It is known practice to compensate for these forces using resilient pads. However, these resilient pads have the disadvantage of being particularly expensive since they are made in particular from silicone. Silicone is selected because its fire resistance properties are acceptable for the intended fields of application. Other materials are known in the prior art, such as the use of EPDM (ethylene-propylene-diene monomer) or PU (polyurethane) for these resilient pads.

It is also known practice to provide plates for thicker heat exchangers. However, such a solution has the disadvantage of increasing the mass of the vehicle, thereby increasing its energy consumption.

### SUMMARY OF THE INVENTION

The invention aims to overcome the disadvantages of the prior art by proposing in particular a reinforcing plate configured to be attached to a thermal regulation device, in particular a cooling device, for an electrical component liable to give off heat during operation, in particular for an electrical energy storage module, this device comprising an upper plate and a lower plate assembled with the upper plate to together form a plurality of circulation channels for a heat transfer fluid, characterized in that the reinforcing plate is arranged on at least one portion of the lower plate.

The invention makes it possible to withstand the mechanical compression forces exerted on the thermal regulation device while avoiding the use of resilient pads. The invention also makes it possible to minimize the extra mass added to the vehicle. The invention also has the advantage of offering a solution compatible with various types of thermal regulation devices or being adapted to the needs of each of these thermal regulation devices.

The invention also relates to a thermal module comprising a thermal regulation device, in particular a cooling device, for an electrical component liable to give off heat during operation, in particular for an electrical energy storage module, this device comprising an upper plate and a lower plate assembled with the upper plate to together form a plurality of circulation channels for a heat transfer fluid, the module also comprising at least one reinforcing plate as described above.

According to one aspect of the invention, the reinforcing plate is configured to be in contact with a face of the lower plate that is opposite a face of the lower plate that is in contact with the upper plate.

According to one aspect of the invention, the reinforcing plate comprises a first section configured to be in contact with a portion of the lower plate that comprises at least a portion of the plurality of circulation channels.

According to one aspect of the invention, the reinforcing plate may comprise a second section configured to be in contact with a portion of the lower plate that does not comprise any circulation channels.

According to one aspect of the invention, the reinforcing plate comprises at least one rib.

According to one aspect of the invention, the rib comprises a main direction of extension, said direction being arranged in a plane of the reinforcing plate and in a direction intersecting the main orientation of the plurality of circulation channels of the portion of the lower plate on which the reinforcing plate is arranged, preferably perpendicular to the main orientation of the circulation channels of the portion of the lower plate on which the reinforcing plate is arranged. It will thus be appreciated that said main orientation of the channels is the orientation of the channels configured to be arranged facing the first section of the reinforcing plate, said first section comprising the at least one rib. The main orientation of the plurality of channels must be understood to mean the orientation of the largest dimension in which the channels in question extend.

According to one aspect of the invention and alternatively, the rib is arranged parallel to the plurality of circulation channels of the portion of the lower plate on which the reinforcing plate is arranged.

According to one aspect of the invention, the reinforcing plate comprises an upper surface configured to be in contact with the at least one portion of the lower plate, the rib is formed by a cavity extending from the upper surface of the reinforcing plate and perpendicular to the lower plate of the thermal regulation device. Advantageously, the rib may be obtained by stamping the reinforcing plate, and therefore the reinforcing plate makes it possible to optimize the amount of material required to obtain the part while retaining the robustness provided by the rib.

According to one aspect of the invention, the cavity may comprise thermal insulation.

It will also be appreciated that the rib may be obtained by extrusion or molding of the reinforcing plate. The rib may be formed integrally and without cavities, in other words in a cross-sectional view of the reinforcing plate, the rib is solid.

According to one aspect of the invention, the reinforcing plate comprises a plurality of ribs as described above.

According to one aspect of the invention, the plurality of ribs comprises ribs of different dimensions.

According to one aspect of the invention, at least one rib with a dimension different to the other ribs may be arranged on a periphery of the reinforcing plate or alternatively, the at least one rib with a different dimension may be arranged at the center of the reinforcing plate.

According to one aspect of the invention, the plurality of ribs comprises a set of straight segments that are parallel to one another. It will be appreciated that these straight segments define the main orientation of elongation of the ribs.

According to one aspect of the invention, the plurality of ribs comprises U-shaped segments connecting neighboring straight segments.

According to one aspect of the invention and alternatively, the U-shaped segments may be replaced by straight or V-shaped segments.

According to one aspect of the invention, the plurality of ribs comprises at least two groups of ribs, each group of ribs being configured to be arranged facing a different portion of the plurality of channels.

According to one aspect of the invention, each of the groups of ribs is configured to be arranged on portions of the plurality of channels having a main direction of extension different to another portion. It will therefore be appreciated that the various groups of ribs have different main directions of extension.

According to one aspect of the invention, one of the groups of ribs comprises at least two ribs, each of which is arranged on at least one side of another group of ribs, and said ribs arranged on the sides may have different dimensions to the ribs of the group that it adjoins, preferably larger dimensions. This makes it possible to adapt the rigidity of the reinforcing plate optimally depending on the thermal regulation device.

According to one aspect of the invention, the reinforcing plate comprises, over at least a portion of its periphery, a peripheral wall extending mainly perpendicular to the main planes of elongation of the upper plate and the lower plate. Thus, and advantageously, the wall further increases the strength of the reinforcing plate, especially with respect to mechanical torsional and bending stresses on the lower plate of the thermal regulation device.

According to one aspect of the invention, the wall is formed integrally with the reinforcing plate, preferably obtained by stamping.

According to one aspect of the invention, the reinforcing plate covers 25%, preferably 50%, even more preferably the entire surface of the lower plate.

The invention also relates to a reinforcing device comprising a plurality of reinforcing plates such as the reinforcing plate described above and configured to be attached to the same lower plate of a thermal regulation device.

According to one aspect of the invention, each plate comprises at least one rib as described above.

According to one aspect of the invention, each reinforcing plate comprises at least one rib oriented in a direction other than the direction of a rib of another plate.

According to one aspect of the invention, the reinforcing plate has a shape preferably similar to the lower plate, but alternatively it may have a shape other than the shape of the lower plate. It will thus be appreciated that when the lower plate has a mainly flat shape, the reinforcing plate is preferably flat.

According to one aspect of the invention, the reinforcing plate may for example be a quadrilateral or a T-shaped polygon.

According to one aspect of the invention, the reinforcing plate is produced from metal, preferably aluminum. Metal has the advantage of not being flammable, unlike the resilient pads of the prior art. In addition, it is superior in terms of wear resistance and recyclability.

According to one aspect of the invention and alternatively, the reinforcing plate may be made of a composite. This has the advantage of providing good mechanical strength while being more lightweight than metal, which, in the example of use in a vehicle, makes it possible to reduce energy consumption for propulsion of the vehicle.

According to one aspect of the invention, the reinforcing plate is configured to be brazed with the lower plate and the upper plate of the thermal regulation device. This has the advantage of offering greater and stronger structural reinforcement than a bond using adhesive, for example.

According to one aspect of the invention and alternatively, the reinforcing plate may be laser welded to the lower plate of the thermal regulation device.

According to one aspect of the invention and again alternatively, the reinforcing plate may be riveted to the lower plate of the thermal regulation device.

According to one aspect of the invention, it is also possible for the reinforcing plate to be adhesively bonded to the lower plate of the thermal regulation device.

According to one aspect of the invention, the reinforcing plate has a thickness of between 0.5 and 1.3 mm.

According to one aspect of the invention, the thermal regulation device may include spaces for receiving the components to be cooled, in particular battery cells, the module also comprises a plurality of reinforcing plates, each reinforcing plate being arranged facing a space.

According to one aspect of the invention, the lower plate and the upper plate each have a thickness of up to 3 mm, more often between 0.8 mm and 1.3 mm.

According to one aspect of the invention, the heat transfer fluid may in particular be a refrigerant fluid, in particular a fluid selected from the refrigerant fluids R134a, R1234yf and R744, or a glycol/water mixture.

According to one aspect of the invention, the plurality of channels may comprise mainly rectilinear or curved channels.

According to one aspect of the invention, the plurality of channels may comprise rectilinear sections connected to curved sections.

According to one aspect of the invention, the plurality of channels of the lower plate of the thermal regulation device is preferably formed by stamping.

According to one aspect of the invention, the channels extend from a face of the lower plate in contact with a face of the upper plate, in a direction opposite to that face.

According to one aspect of the invention, the channels are formed by cavities formed in the lower plate and closed off by stacking with the upper plate.

According to one aspect of the invention, since the thickness of the lower plate is smaller than the width of the channels, the cavities forming the channels form protrusions extending outwardly from a face opposite the face in contact with the upper plate.

According to one aspect of the invention, the reinforcing plate is in contact only with the protrusions of the lower plate.

According to one aspect of the invention, the channels extend between a common inlet and a common outlet for heat transfer fluid.

According to one aspect of the invention, a flange may be connected to this inlet and outlet to provide connections.

According to one aspect of the invention, the reinforcing plate comprises attachment means configured to attach the thermal regulation device to a frame.

According to one aspect of the invention, the attachment means may comprise holes passing right through the reinforcing plate and configured to receive attachment elements such as screws, rivets and other similar elements known to those skilled in the art.

According to one aspect of the invention, the holes in the reinforcing plate may be arranged in rectilinear groups across the reinforcing plate.

According to one aspect of the invention, the holes may alternatively or additionally be arranged on the periphery of the reinforcing plate.

According to one aspect of the invention, the upper plate and/or the lower plate may comprise at least one attachment lug extending from an edge of the upper plate and/or the lower plate, the attachment lug preferably comprising at least one hole of the attachment means.

According to one aspect of the invention, the at least one attachment lug is arranged in a plane parallel to the main planes of elongation of the upper plate and the lower plate.

According to one aspect of the invention, the reinforcing plate is arranged partially on at least one of the attachment lugs.

The invention also relates to a system comprising an electrical component liable to give off heat during operation, in particular for an electrical energy storage module, a thermal module described above, designed to regulate the temperature of the component, this component, in particular battery cells, being in thermal contact with the upper plate of the thermal regulation device.

### BRIEF DESCRIPTION OF THE DRAWINGS

Further features and advantages of the invention will become more clearly apparent upon reading the following description, which is given by way of illustrative and nonlimiting example, and from the appended drawings, in which:

FIG. 1 schematically depicts a thermal module comprising a reinforcing plate according to an embodiment of the invention;

FIG. 2 schematically depicts a thermal module comprising a reinforcing plate according to another embodiment of the invention.

### DETAILED DESCRIPTION

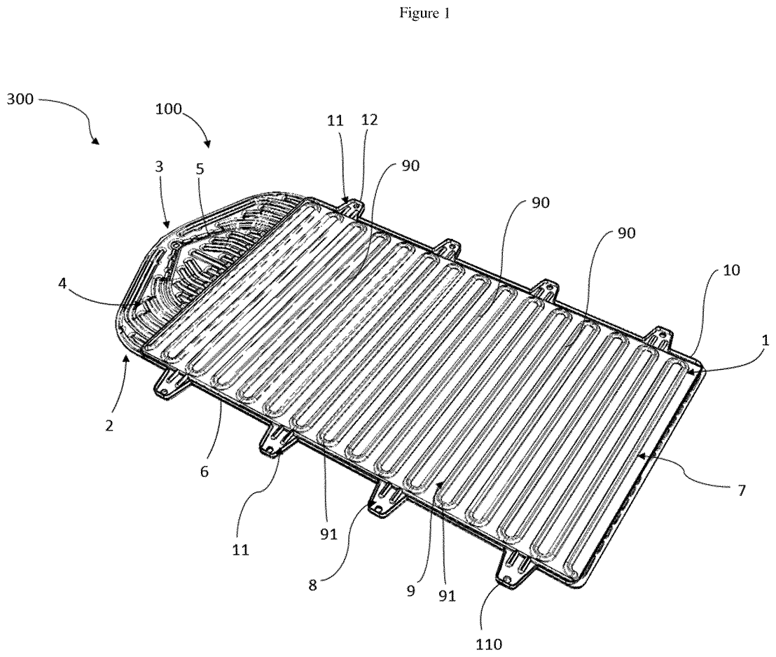

FIG. 1 shows a reinforcing plate 1 configured to be attached to a thermal regulation device 100, in particular a cooling device, for an electrical component (not shown in the figures) liable to give off heat during operation, in particular for an electrical energy storage module, this device 100 comprising an upper plate 2 and a lower plate 3 assembled with the upper plate 2 to together form a plurality of circulation channels 4 for a heat transfer fluid, characterized in that the reinforcing plate 1 is arranged on at least one portion of the lower plate 3.

The invention also relates to a thermal module 300 comprising a thermal regulation device 100, in particular a cooling device, for an electrical component liable to give off heat during operation, in particular for an electrical energy storage module, this device 100 comprising an upper plate 2 and a lower plate 3 assembled with the upper plate 2 to together form a plurality of circulation channels 4 for a heat transfer fluid, the module 300 also comprising at least one reinforcing plate 1 as described above.

The reinforcing plate 1 is configured to be in contact with a face 5 of the lower plate 3 that is opposite a face 6 of the lower plate 3 that is in contact with the upper plate 2.

The reinforcing plate 1 comprises a first section 7 configured to be in contact with a portion of the lower plate 3 that comprises at least a portion of the plurality of circulation channels 4.

The reinforcing plate 1 may comprise a second section 8 configured to be in contact with a portion of the lower plate 3 that does not comprise any circulation channels 4.

The reinforcing plate 1 comprises at least one rib 9.

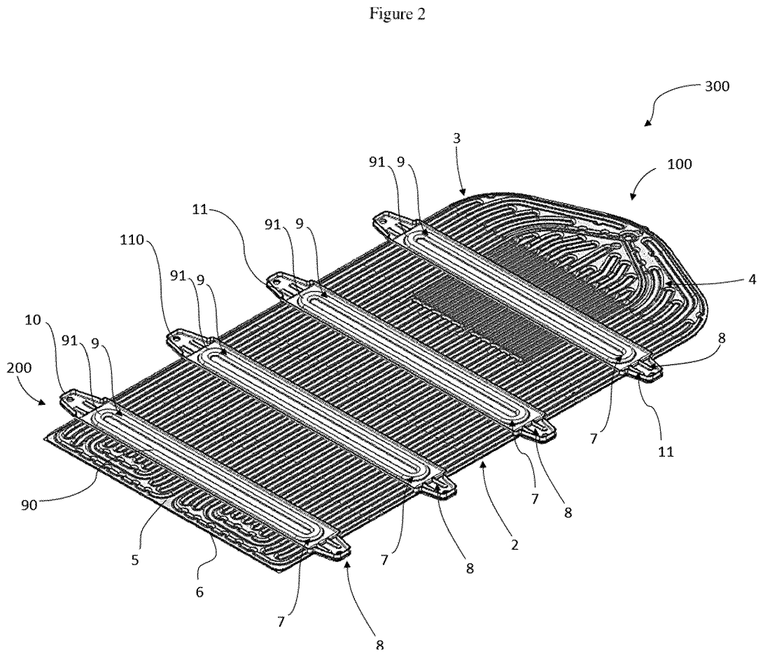

The rib 9 comprises a main direction of extension, said direction being arranged in a plane of the reinforcing plate 1 and in a direction intersecting the main orientation of the plurality of circulation channels 4 of the portion of the lower plate 3 on which the reinforcing plate 1 is arranged, preferably perpendicular to the main orientation of the circulation channels 4 of the portion of the lower plate 3 on which the reinforcing plate 1 is arranged. It will thus be appreciated that said main orientation of the channels 4 is the orientation of the channels 4 configured to be arranged facing the first section 7 of the reinforcing plate 1, said first section 7 comprising the at least one rib 9. The main orientation of the plurality of channels must be understood to mean the orientation of the largest dimension in which the channels 4 in question extend. Thus, in the examples of FIGS. 1 and 2, the ribs 9 of the reinforcing plate 1 extend perpendicular to the channels 4 placed under these ribs 9. In FIGS. 1 and 2, the channels 4 extend mainly along the length of the lower plate 3 and therefore the ribs 9 extend mainly in a direction arranged across the width of the lower plate 3.

Alternatively, the rib 9 is arranged parallel to the plurality of circulation channels 4 of the portion of the lower plate 3 on which the reinforcing plate 1 is arranged.

The reinforcing plate 1 comprises an upper surface 10 configured to be in contact with the at least one portion of the lower plate 3, the rib 9 is formed by a cavity extending from the upper surface 10 of the reinforcing plate 1 and perpendicular to the lower plate 3 of the thermal regulation device 100. Advantageously, the rib 9 may be obtained by stamping the reinforcing plate 1, and therefore the reinforcing plate 1 makes it possible to optimize the amount of material required to obtain the part while retaining the robustness provided by the rib 9.

The cavity may comprise thermal insulation.

It will also be appreciated that the rib 9 may be obtained by extrusion or molding of the reinforcing plate 1. The rib 9 may be formed integrally and without cavities, in other words in a cross-sectional view of the reinforcing plate 1, the rib 9 is solid.

The reinforcing plate 1 comprises a plurality of ribs 9 as described above.

The plurality of ribs 9 comprises ribs 9 with different dimensions, for example at least one rib 9 with a dimension different to the other ribs 9 may be arranged on a periphery of the reinforcing plate 1 or alternatively, the at least one rib 9 with a different dimension may be arranged at the center of the reinforcing plate 1.

The plurality of ribs 9 comprises a set of straight segments 90 that are parallel to one another. It will be appreciated that these straight segments 90 define the main orientation of elongation of the ribs 9.

The plurality of ribs 9 comprises U-shaped segments 91 connecting neighboring straight segments 90.

Alternatively, the U-shaped segments 91 may be replaced by straight or V-shaped segments.

The plurality of ribs 9 comprises at least two groups of ribs 9, each group of ribs 9 being configured to be arranged facing a different portion of the plurality of channels 4; this has not been shown in the figures.

Each of the groups of ribs 9 is configured to be arranged on portions of the plurality of channels 4 having a main direction of extension different to another portion.

One of the groups of ribs 9 comprises at least two ribs 9, each of which is arranged on at least one side of another group of ribs, and said ribs 9 arranged on the sides may have different dimensions to the ribs 9 of the group that it adjoins, preferably larger dimensions. This makes it possible to adapt the rigidity of the reinforcing plate 1 optimally depending on the thermal regulation device 100.

As shown in FIGS. 1 and 2, the reinforcing plate 1 comprises, over at least a portion of its periphery, a peripheral wall 10 extending mainly perpendicular to the main planes of elongation of the upper plate 2 and the lower plate 3. Thus, and advantageously, the wall 10 further increases the strength of the reinforcing plate 1, especially with respect to mechanical torsional and bending stresses on the lower plate 3 of the thermal regulation device 100.

The wall 10 is formed integrally with the reinforcing plate 1, preferably obtained by stamping.

According to a first embodiment of the invention shown in FIG. 1, a single reinforcing plate is arranged on the thermal regulation device. The reinforcing plate 1 covers 25%, preferably 50%, even more preferably the entire surface of the lower plate 3.

As shown in FIG. 2 and according to a second embodiment of the invention, the invention also relates to a reinforcing device 200 comprising a plurality of reinforcing plates 1 such as the reinforcing plate 1 described above and configured to be attached to the same lower plate 3 of a thermal regulation device 100.

Each plate 1 comprises at least one rib 9 as described above.

Each reinforcing plate 1 comprises at least one rib 9 oriented in a direction other than the direction of a rib 9 of another plate 1.

The reinforcing plate 1 has a shape preferably similar to the lower plate 3, but alternatively it may have a shape other than the shape of the lower plate 3. It will thus be appreciated that when the lower plate 3 has a mainly flat shape, the reinforcing plate 1 is preferably flat.

The reinforcing plate 1 may for example be a quadrilateral or a T-shaped polygon.

The reinforcing plate 1 is produced from metal, preferably aluminum. Metal has the advantage of not being flammable, unlike the resilient pads of the prior art. In addition, it is superior in terms of wear resistance and recyclability.

Alternatively, the reinforcing plate 1 may be made of a composite. This has the advantage of providing good mechanical strength while being more lightweight than metal, which, in the example of use in a vehicle, makes it possible to reduce energy consumption for propulsion of the vehicle.

The reinforcing plate 1 is brazed with the lower plate 3 and the upper plate 2 of the thermal regulation device 100.

Alternatively, the reinforcing plate 1 may be laser welded to the lower plate 3 of the thermal regulation device 100.

Again alternatively, the reinforcing plate 1 may be riveted to the lower plate 3 of the thermal regulation device 100.

It is also possible for the reinforcing plate 1 to be adhesively bonded to the lower plate 3 of the thermal regulation device 100.

The reinforcing plate 1 has a thickness of between 0.5 and 1.3 mm.

The thermal regulation device 100 may include spaces for receiving the components to be cooled, in particular battery cells, the module 300 may also comprise a plurality of reinforcing plates 1, each reinforcing plate 1 being arranged facing a space.

The lower plate 3 and the upper plate 2 each have a thickness of up to 3 mm, more often between 0.8 mm and 1.3 mm.

The heat transfer fluid may in particular be a refrigerant fluid, in particular a fluid selected from the refrigerant fluids R134a, R1234yf and R744, or a glycol/water mixture.

The plurality of channels 4 may comprise mainly rectilinear or curved channels.

The plurality of channels 4 may comprise rectilinear sections connected to curved sections.

The plurality of channels 4 of the lower plate 3 of the thermal regulation device 100 is preferably formed by stamping.

The channels 4 extend from a face of the lower plate 3 in contact with a face of the upper plate 2, in a direction opposite to that face.

The channels 4 are formed by cavities formed in the lower plate 3 and closed off by stacking with the upper plate 2.

Since the thickness of the lower plate 3 is smaller than the width of the channels 4, the cavities forming the channels 4 form protrusions extending outwardly from a face opposite the face in contact with the upper plate 2.

The reinforcing plate 1 is in contact only with the protrusions of the lower plate 3.

The channels 4 extend between a common inlet and a common outlet for heat transfer fluid.

A flange may be connected to this inlet and outlet to provide connections.

The reinforcing plate 1 comprises attachment means 11 configured to attach the thermal regulation device 100 to a frame.

The attachment means 11 may comprise holes 110 passing right through the reinforcing plate 1 and configured to receive attachment elements such as screws, rivets and other similar elements known to those skilled in the art.

The holes 110 in the reinforcing plate 1 may be arranged in rectilinear groups across the reinforcing plate 1.

The holes 110 may alternatively or additionally be arranged on the periphery of the reinforcing plate 1.

The upper plate 2 and/or the lower plate 3 may comprise at least one attachment lug 12 extending from an edge of the upper plate 2 and/or the lower plate 3, the attachment lug 12 preferably comprising at least one hole 110 of the attachment means 11.

The at least one attachment lug 12 is arranged in a plane parallel to the main planes of elongation of the upper plate 2 and the lower plate 3.

As shown in FIGS. 1 and 2, the reinforcing plate 1 is arranged partially on at least one of the attachment lugs 12.

The invention also relates to a system comprising an electrical component liable to give off heat during operation, in particular for an electrical energy storage module, a thermal module 300 described above, designed to regulate the temperature of the component, this component, in particular battery cells, being in thermal contact with the upper plate 2 of the thermal regulation device 100.

1. A thermal module comprising a thermal regulation device, for an electrical component liable to give off heat during operation, for an electrical energy storage module, the thermal regulation device comprising:
an upper plate; and
a lower plate assembled with the upper plate to together form a plurality of circulation channels for a heat transfer fluid, wherein the thermal module comprises at least one reinforcing plate arranged on at least one portion of the lower plate.

2. The thermal module as claimed in claim 1, wherein the reinforcing plate comprises at least one rib.

3. The thermal module as claimed in claim 2, wherein the rib comprises a main direction of extension, said direction being arranged in a plane of the reinforcing plate and in a direction intersecting the main orientation of the plurality of circulation channels of the portion of the lower plate on which the reinforcing plate is arranged, perpendicular to the main orientation of the circulation channels of the portion of the lower plate on which the reinforcing plate is arranged.

4. The thermal module as claimed in claim 2, wherein the rib is arranged parallel to the plurality of circulation channels of the portion of the lower plate on which the reinforcing plate is arranged.

5. The thermal module as claimed in claim 2, wherein the reinforcing plate comprises an upper surface configured to be in contact with the at least one portion of the lower plate, the rib is formed by a cavity extending from the upper surface of the reinforcing plate and perpendicular to the lower plate of the thermal regulation device.

6. The thermal module as claimed in claim 1, wherein the reinforcing plate comprises, over at least a portion of its periphery, a peripheral wall extending mainly perpendicular to the main planes of elongation of the upper plate and the lower plate.

7. The thermal module as claimed in claim 1, wherein the reinforcing plate is brazed with the lower plate and the upper plate of the thermal regulation device.

8. The thermal module as claimed in claim 1, wherein the reinforcing plate covers 25%, of the surface of the lower plate.

9. A thermal module comprising:
a reinforcing device comprising a plurality of reinforcing plates as claimed in claim 1 and configured to be attached to the same lower plate of a thermal regulation device.

10. A system comprising: an electrical component liable to give off heat during operation, for an electrical energy storage module; and a thermal module as claimed in claim 1, designed to regulate the temperature of the electrical component, in thermal contact with the upper plate of the thermal regulation device.
